(19) United States
(12) Patent Application Publication
(10) Pub. No.: US 2010/0104872 A1
(43) Pub. Date: Apr. 29, 2010

(54) BIOBASED WATERBORNE SYNTHETIC POLYURETHANE HYBRID LATEXES AND FILMS

(75) Inventor: Yongshang LU, Ames, IA (US)

Correspondence Address: ARCHER DANIELS MIDLAND COMPANY, 4666 FARIES PARKWAY, DECATUR, IL, 62526, US

(73) Assignee: Archer-Daniels-Midland Company, Decatur, IL (US)

(21) Appl. No.: 12/557,170

(22) Filed: Sep. 10, 2009

Related U.S. Application Data
(60) Provisional application No. 61/097,722, filed on Sep. 17, 2008.

(51) Int. Cl. C08G 18/06; B32B 5/16

(52) U.S. Cl. 428/402; 525/123

(57) ABSTRACT

This work provides a new way of utilizing renewable resources to prepare environmentally friendly biobased hybrid latexes with high performance for coating applications. Also provided are biobased polyurethane/acrylic hybrid films having good properties.

This Invention was made under CRADA AL-C-2005-01 between Archer Daniels Midland Company and Ames Laboratory, Iowa State University, operated for the U.S. Department of Energy. As such the U.S. Government may have certain rights in this invention.

Polyurethanes (PU) ranging from high performance elastomers to tough thermoplastics are of great interest for applications in coatings, adhesives, medical devices, binders, sealants, and the textile industry. Conventional PU products, such as coatings and adhesives, contain a significant amount of organic solvents and sometimes even free isocyanate monomers. To address health, safety, and environmental concerns, solvent-based polyurethanes have been gradually replaced by waterborne PU. Waterborne PU have other advantages relative to conventional solvent-borne PU, including low viscosity at high molecular weight and good applicability.

Polyurethanes are obtained by the reaction of polyisocyanates with polyhydroxy compounds. Compounds containing groups such as amino and carboxyl groups may also be used. Thus, polyurethanes may contain aliphatic and aromatic hydrocarbon residues and ester, ether, amide and urea groups in addition to urethane groups.

Synthetic latexes are commercially made by emulsion polymerization techniques from styrene-butadiene copolymer, acrylate resins, polyvinyl acetate, and similar materials. The particle size of the latex solids typically ranges from 0.05 to 0.15 microns; thus, acrylic polymer latexes are truly colloidal suspensions. Their chief use is as a binder in exterior and interior paints, replacing drying oils; they are also used for foams and coatings. Emulsion polymerization, a heterogeneous free radical polymerization process involving emulsification of one or more monomers in a continuous aqueous phase and stabilization of the droplets by a surfactant, is used to produce waterborne resins with various colloidal and physicochemical properties. Materials produced by emulsion polymerization include acrylic polymer latexes containing a combination of monomers, such as butyl acrylate, methyl methacrylate, and acrylic acid.

Acrylic polymer latex films may possess excellent weatherability, hardness, and water and alkali resistance due to the carbon-carbon bonds of the main polymer chains, making them very useful for coatings, paper and textile finishes, cement additives, and other applications. However, the elasticity and abrasion resistance of acrylic resins are inferior to those of urethane resins. To improve the performance of acrylic polymers with respect to toughness, flexibility, abrasion resistance, and film-forming properties, PU and acrylics can be combined into hybrid latexes by blending, seeded emulsion polymerization, interpenetrating polymer networks (IPN), crosslinking and graft copolymerization. However, it has been observed (Kukanja et al., The structure and properties of acrylic-polyurethane hybrid emulsions and comparison with physical blends, Journal of Applied Polymer Science, Vol. 78, 67-80, 2000); Wang, et al. Hybrid polymer latexes—acrylics-polyurethane: II. Mechanical properties, Polym. Adv. Technol. 2005; 16: 139-145; Published online 17 Jan. 2005) that incorporation of acrylic into polyurethane in hybrid emulsions has caused worsening of desirable polyurethane properties, such as stiffness, measured as Young's modulus, and mechanical strength, measured as tensile strength and elongation under load.

The present disclosure, however, enables polyurethane/acrylic hybrid latexes and films made therefrom in which the desirable polyurethane properties are improved, not worsened, by the incorporation of acrylics. Methods for synthesizing polyurethane/acrylic hybrid latexes and films made therefrom having desirable properties are described in Lu, Y and Larock, R. “New hybrid latexes from a soybean oil-based waterborne polyurethane and acrylics via emulsion polymerization” published on Web Sep. 18, 2007, ref No. 10.1021/bm700522zz, American Chemical Society.

Synthetic latexes made from polyurethane/acrylic hybrid emulsions have a further significant drawback in that the particle size of the latex particles increases as the content of acrylic increases past 40%. Consequently, a mixture of polydisperse particle sizes is formed if latex particles containing greater than 40% acrylic are blended with latexes containing less than 40% acrylic after formation, a mixture of polydisperse particle sizes is formed. The resulting heterogeneity of particle sizes can prevent good mixing, promote settling, and provide non-uniform properties in films prepared from a mixture of the latex particle sizes. The present disclosure provides polyurethane/acrylic hybrid emulsions having particle sizes that do not depend on the content of acrylic, overcoming this drawback and allowing blending of hybrid emulsions having dissimilar acrylic content while retaining a uniform particle size.

Additionally, there continues to be a need for latexes made from biobased materials instead of petroleum based materials. This work, especially, provides a new way of utilizing renewable, biobased resources to prepare environmentally friendly PU/acrylic hybrid latexes with high performance for coating applications.

In this regard, biobased materials may be differentiated from petroleum derived materials, for example, by their carbon isotope ratios using ASTM International Radioisotope Standard Method D 6866. Completely biobased materials may have a 100% biobased carbon isotope ratio. According to certain embodiments, biobased materials may have from 1% to 99.9% biobased carbon isotope ratio. According to other embodiments, biobased materials may have from 50% to 99.9% biobased carbon isotope ratio. As used herein the term “biobased carbon isotope ratio” means a composition or component of a composition having a carbon isotope ratio, as determined, for example, by ASTM International Radioisotope Standard Method D 6866, that is indicative of a composition composed, in whole or in significant part, of biological products or renewable agricultural materials (including plant, animal and marine materials) or forestry materials. As used herein, the term “bioderived” means derived from or synthesized by a renewable biological feedstock, such as, for example, an agricultural, silvicultural (forestry), plant, bacterial, or animal feedstock. As used herein, the term “biobased” means a product that is composed, in whole or in significant part, of biological products or renewable agricultural materials (including plant, animal and marine materials) or forestry materials. As used herein, the term “natural” means a product that composed, in whole or in significant part, of biological products or renewable agricultural materials (including plant, animal and marine materials) or forestry materials. As used herein, the term “petroleum derived” means a product derived from or synthesized from petroleum or a petrochemical feedstock.

The unique advantages of our biobased PU/acrylic hybrid waterborne materials as coatings include: reduction of volatile organic compound (VOC) and hazardous air pollutant (HAP) emissions; conventional application processes can be used; toxicity and odor are reduced, resulting in improved worker safety and comfort; good storage life; hazardous wastes are reduced or eliminated; they combine the advantages of acrylics and polyurethanes, resulting in coating materials with good weatherability, good hardness, better water and alkali resistance, higher toughness, good flexibility, good abrasion resistance, and good film-forming properties; the coatings exhibit tight interfacial adhesion to substrates; the thermophysical and mechanical properties of the coatings are equal to or better than petroleum-based polyurethane/acrylics hybrid coatings; and the materials contain 15-70% vegetable oil-based polyols, which exceeds the renewable resource content of conventional waterborne coatings.

The present invention is thus directed in one aspect to a composition comprising a biobased waterborne polyurethane/acrylic hybrid latex. Methods for synthesizing the composition are also disclosed.

The present invention is also directed to a composition comprising a biobased waterborne polyurethane/acrylic hybrid latex, wherein the double bonds of fatty acids in biobased waterborne polyurethane/acrylic hybrid latex are copolymerized with acrylic monomers. The particle size of latex particles is uniform, and may be 125±20 nanometers. Graft-interpenetrating polymer networks and semi-interpenetrating polymer networks may form. The biobased waterborne polyurethane/acrylic hybrid latex may comprise triglyceride oils, such as soybean oil, epoxidized triglyceride oils, such as epoxidized soybean oil, or combinations thereof. Films may be formed from the biobased polyurethane/acrylic hybrid latex. Film properties that may be obtained include displaying only one loss factor peak, a temperature-dependent storage modulus behavior, a temperature-dependent storage modulus behavior between the temperature-dependent storage modulus behavior of polyurethane and the temperature-dependent storage modulus behavior of polyacrylate film, a clear film having a thermal stability greater than the thermal stability of a polyurethane film such that, for instance, the temperature at which 5 percent degradation of the biobased polyurethane/acrylic hybrid latex film occurs is greater than the temperature at which 5 percent degradation of a polyurethane film occurs, a stiffness greater than the stiffness of a polyurethane film and that increases with increasing content of acrylic, a tensile strength greater than the tensile strength of either a polyurethane film or a polyacrylate film, an elongation at break greater than the elongation at break of a polyurethane film or a polyacrylate film, and combinations of any of these properties.

The present invention is also directed in a further aspect to a polyurethane/acrylic hybrid latex wherein the particle size of the latex particles is unrelated to the ratio of polyurethane to acrylic. The latex may exhibit properties selected from the group consisting of a mechanical strength that increases with increasing acrylic content in the film, a tensile strength that increases with increasing acrylic content in the film, and a stiffness that increases with increasing acrylic content in the film.

### BRIEF DESCRIPTION OF THE DRAWINGS

FIG. 1 is a graph depicting the progress of the emulsion polymerization of hybrid latexes having different ratios of biobased polyurethane and acrylate that may be carried out as described herein.

FIG. 2 is a spectrogram showing the Fourier Transform Infrared spectra of films made from hybrid latexes having different ratios of biobased polyurethane and acrylate that may be obtained as described herein.

FIG. 3 is a graph of the content of insoluble material in hybrid latexes having different ratios of biobased polyurethane and acrylate that may be obtained as described herein.

FIG. 4 is a spectrogram showing the solid state 13C Nuclear Magnetic Resonance spectra of hybrid latex films having different ratios of biobased polyurethane and acrylate that may be obtained as described herein.

FIG. 5 is a group of micrographs obtained by transmission electron microscopy depicting (a) a biobased polyurethane dispersion; (b) PUA-25 hybrid latex (biobased polyurethane/acrylic hybrid latex containing 25% acrylic), and (c) PUA 50 hybrid latex (biobased polyurethane/acrylic hybrid latex containing 50% acrylic) that may be obtained as described herein. Scale bar=500 nm.

FIG. 6 is a group of graphs depicting some rheological characteristics of biobased polyurethane/acrylic hybrid latex films that may be obtained as described herein. Legend: (a) storage modulus; (b) loss factor (tan delta). The biobased polyurethane/acrylic hybrid latex films are identified as PUA-10, PUA-25, PUA-35, PUA-50, and PUA-75, wherein the number represents the weight percent of acrylic in the latex.

FIG. 7 is a graph depicting the glass transition temperature (Tg) of biobased polyurethane/acrylic hybrid latex films that may be obtained as described herein.

FIG. 8 is a graph showing the weight loss of biobased polyurethane/acrylic hybrid latex films that may be obtained as described herein as a function of temperature, as determined by thermogravimetric analysis. The biobased polyurethane/acrylic hybrid latex films are identified as PUA-10, PUA-25, PUA-35, PUA-50, and PUA-75, wherein the number represents the weight percent of acrylic in the latex.

FIG. 9 is a graph depicting some mechanical properties (tensile strength, Young's modulus, and elongation at break) of films that may be obtained as described herein.

FIG. 10 is a graph depicting some stress-strain rheological characteristics of biobased polyurethane/acrylic hybrid latex films that may be obtained as described herein. The biobased polyurethane/acrylic hybrid latex films are identified as PUA-10, PUA-25, PUA-35, PUA-50, and PUA-75, wherein the number represents the weight percent of acrylic in the latex.

FIG. 11 presents scheme 1, a proposed reaction mechanism occurring in one embodiment of producing biobased waterborne polyurethanes and films described herein. BA=butyl acrylate; MMA=methylmethacrylate.

FIG. 12 presents structure 1 depicting a schematic representation of one possible type of polyol formed in producing biobased waterborne polyurethanes and films described herein.

FIG. 13 (PRIOR ART) presents the broad variations in particle size of petroleum-based hybrid polyurethane/acrylic hybrid latexes as presented by Kukanja et al., the structure and properties of acrylic-polyurethane hybrid emulsions and a comparison with physical blends, Journal of Applied Polymer Science, Vol. 78, 67-80, 2000.

FIG. 14 (PRIOR ART) presents stress-strain curves of petroleum-based polyurethane/acrylate hybrid polymer latex films made from petroleum-sourced polypropylene glycol (FIG. 7 from Wang, et al. Hybrid polymer latexes—acrylics-polyurethane: II. Mechanical properties, Polym. Adv. Technol. 2005; 16: 139-145; Published online 17 Jan. 2005).

Polyols used for synthesis of polyurethanes are multifunctional hydroxy-bearing compounds. They fall into several categories based on chemical type. Reactive hydroxyl materials in common use are polyethers, polyesters, polycaprolactones, polybutoximes, polycarbonates, acrylics, alkyds, castor oil, glucosides, sucrose derivatives.

Unlike castor oil, glucosides, and sucrose derivatives, most vegetable oils and animal oils comprise triacylglycerols without any free hydroxyl groups. These biobased oils comprise carboxylic acids of various chain lengths and varying numbers of carbon-carbon double bonds. For example, soybean oil contains, on average, approximately 4.5 carbon-carbon double bonds per molecule in the fatty-acid side chains. Other triacylglycerols, such as drying oils including linseed oil, contain a greater number of carbon-carbon double bonds. Vegetable oils and animal oils that do not contain free hydroxyl groups can be modified to obtain free hydroxyl groups.

Biobased polyols can be reacted to form biobased polyurethane. Biobased polyols can be reacted with diisocyanate compounds as disclosed herein. Biobased polyurethane can be converted into aqueous (waterborne) polyurethane dispersions by addition of water, as described herein. Biobased polyurethane dispersions can undergo emulsion polymerization with acrylates to form waterborne polyurethane/acrylic hybrid latexes. The reaction may occur as a copolymerization between any double bonds of fatty acids in the biobased polyurethane/acrylic hybrid latex and acrylate monomers. A waterborne polyurethane/acrylic hybrid latex is a water suspension of latex comprising the reaction product of biobased polyurethane and acrylate. The ratio of biobased polyurethane to acrylate may be varied. The acrylate may be methyl methacrylate and/or butyl acrylate. The acrylates may be biobased, such as biobased methyl methacrylate biobased butyl acrylate, or may be mixtures of petroleum based acrylates and biobased acrylates.

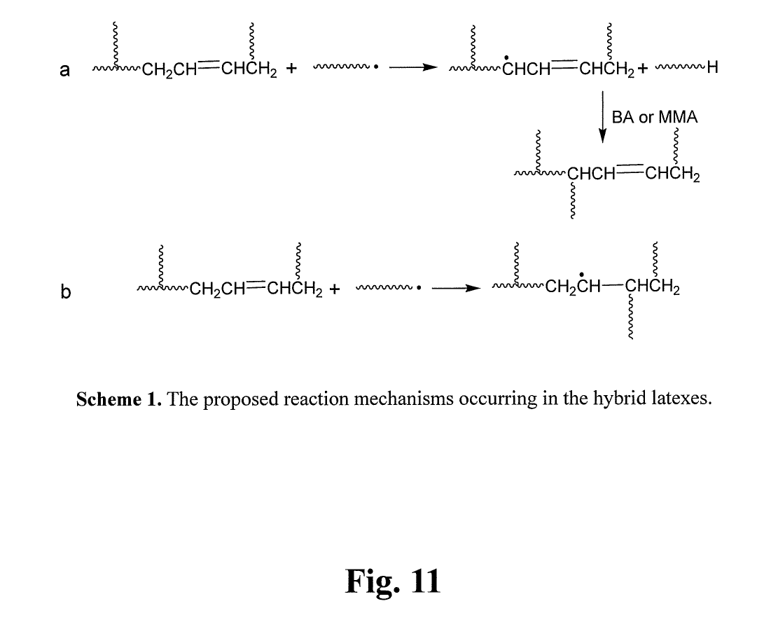

Biobased waterborne polyurethane/acrylic hybrid latexes may be prepared by graft copolymerization during emulsion polymerization, wherein grafting can occur by chain transfer from the propagating free radical to the PU resin as shown in Scheme 1a (FIG. 11). Grafting may also involve copolymerization between the polymerizing radical and the double bonds in the biobased PU (Scheme 1b). Biobased waterborne polyurethane/acrylic hybrid latexes may be prepared by crosslinking between polyurethanes. Both grafting and crosslinking may take place in emulsion polymerization. In an emulsion polymerization, latex particles are formed, and the particle size of the latex particles falls within a range of particle sizes. The particle size range may be limited, so that the particles have a uniform particle size, such as a particle size ranging from 60 nm to 180 nm, or a particle size of 125 nanometers. The latex particles preferably will have a substantially uniform particle size of 125 nanometers plus or minus 20 nanometers (nm).

In an embodiment, new hybrid latexes prepared from a soybean oil-based waterborne PU and acrylic MMA/BA copolymers are synthesized by hybrid emulsion polymerization. PU/acrylic hybrid latexes containing 15-60 wt % biobased polyol may be formed. The synthetic polyurethane acrylic hybrid latexes may contain soybean oil polyol or epoxidized soybean oil polyol.

The biobased PU/acrylate latex film may comprise a single type of polymer system, and films may exhibit a single loss factor peak (indicating the presence of a single type of polymer system). Grafting and interpenetration between acrylics and PU networks may take place. When extensive grafting and interpenetration takes place, a mixture of graft-interpenetrating polymer networks (graft-IPN) and semi-interpenetrating polymer networks (semi-IPN) is formed, where the acrylics are grafted onto the PU to form a graft-IPN, and the linear ungrafted acrylic polymer can be interpenetrated into the PU network to form another semi-IPN. The films preferably will be clear. The films eill preferably also exhibit a temperature-dependent storage modulus behavior between the temperature-dependent storage modulus behavior of polyurethane and the temperature-dependent storage modulus behavior of polyacrylate.

The biobased polyurethane/acrylic hybrid latex films preferably have greater thermal stability than a polyurethane film, having a higher temperature at which 5% degradation of films takes place or at which 50% degradation of films takes place.

Important physical characteristics of films include stiffness, tensile strength, and how much a film deforms under load, such as elongation at break when stretched until breaking. In an embodiment, biobased polyurethane/acrylic hybrid latex films are formed having greater stiffness and tensile strength than polyurethane films.

### EXAMPLE 1

Epoxidized soybean oil was prepared from Wesson soybean oil purchased at the local market. An epoxidized soybean oil was prepared by reaction of the unsaturation sites (double bonds) of the soybean oil with a mixture of formic acid and hydrogen peroxide according to a literature procedure. The soybean oil (100 g) was added to a 500 mL flask, and then hydrogen peroxide (64 g) was added, followed by formic acid (37 g) under vigorous stirring. The reaction was carried out at room temperature for 2.5 h. Then, 150 mL of ethyl acetate and 100 mL of distilled water were added, resulting in two layers. The organic layer was washed with aqueous sodium bicarbonate solution, until a slightly alkaline pH was obtained, and the organic layer was then dried over MgSO4 and filtered. Finally, a clear viscous oil was obtained after removal of the organic solvent under vacuum.

The soybean oil epoxide comprised an average of 2.5 epoxide groups per triglyceride as determined by ¹H NMR spectroscopy on a Varian Unity spectrometer (Varian Associates, Palo Alto, Calif.) at 400 MHz. ¹H NMR (CDCl₃): delta 0.8-1.1 (CH₃ of fatty acids), 1.2-1.8 (CH₂ of fatty acids), 1.9-2.4 (—CH₂C═O—), 2.7 (—C═C—CH₂—C═C—), 2.8-3.2 (—CH of the oxirane rings), 4.1-4.3 (—CH₂—O—C═O), 5.2-5.6 (—CH═CH—). Because the average number of carbon-carbon double bonds present in the original soybean oil was 4.5, the epoxidized soybean oil comprised on average about two remaining carbon-carbon double bonds.

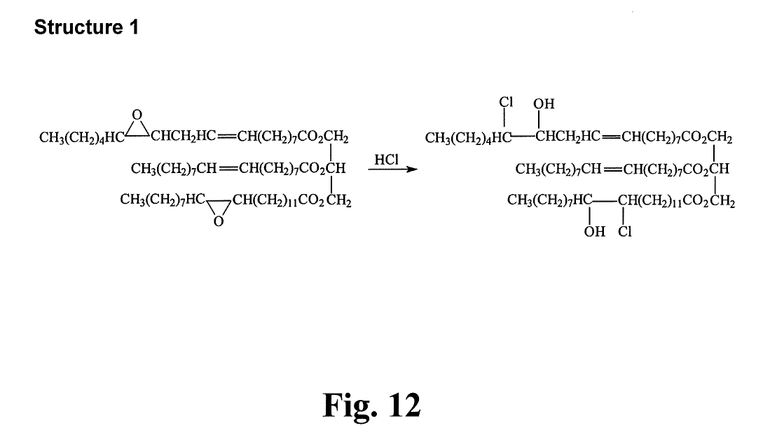

The epoxidized soybean oil was used to prepare biobased polyol (SOL). Briefly, hydrochloric acid (40 g, 37%, 0.4 mol) and acetone (150 mL) were mixed in a flask equipped with a mechanical stirrer and dropping funnel. The resulting mixture was stirred vigorously, while the epoxidized soybean oil (100 g) was added dropwise. The reaction mixture was stirred for an additional 2 h at 40° C. After purification using the same method used for the epoxidized soybean oil mentioned above, a clear, yellow, viscous polyol was obtained. The hydroxyl value of the resulting polyol was 130.9 mg KOH/g as determined by titration. The molecular weight of the biobased polyol was determined to be 1×103 g/mol by a Waters Breeze GPC system (Milford, Mass.) using tetrahydrofuran (THF) as a mobile phase. A schematic representation of one possible type of polyol formed in this reaction is depicted in Structure 1 (FIG. 12). The ring-opening reaction may convert an epoxide ring to a hydroxyl portion and add chlorine to the biobased triacylglycerol epoxide backbone.

The biobased polyol was used to prepare a biobased polyurethane (PU) dispersion (SOL). Soybean oil-based polyol (30 g, 0.0699 mol of OH groups), 11.6 g of toluene 2,4-diisocyanate (TDI, (0.0667 mol), and 4.2 g of dimethylol propionic acid (DMPA, 0.0313 mol) were added to a four-necked flask equipped with a mechanical stirrer, nitrogen inlet, condenser, and thermometer, and the reaction was carried out at 75° C. for 3 h under a dry nitrogen atmosphere. The reaction was then cooled to about 40° C. and 30 g of methyl ethyl ketone (MEK) was added to reduce the viscosity of the polymer, while the solution was stirred vigorously. This PU was then neutralized by the addition of triethylamine (TEA, 3.4 g), followed by dispersion at high speed with distilled water (250 g). MEK was removed from the dispersion under vacuum to provide a biobased waterborne polyurethane dispersion with a solid content of about 20 wt %. The functionality of the biobased polyurethane (PU) dispersion was 2.3.

### EXAMPLE 2

Biobased waterborne synthetic polyurethane/acrylic hybrid latexes were prepared from the biobased waterborne polyurethane dispersion from example 1 by emulsion polymerization. Sodium dodecyl sulfate (SDS, 3 g) and potassium persulfate (KPS, 1 g) were dissolved in 414 g of distilled water. Mixtures totaling 100 g of a mixture of methyl methacrylate (MMA) and butyl acrylate (BA) in the weight ratio 60:40 were added to the above aqueous solution with vigorous stirring to obtain acrylate pre-emulsions. The desired weight of the PU dispersion from example 1 and the acrylate pre-emulsion was placed in a flask and stirred for 30 min at room temperature under a nitrogen atmosphere and then brought to the polymerization temperature of 80° C. for 4 h to obtain hybrid emulsions.

During the polymerization, approximately 5 g portions of the emulsion were taken by a syringe at intervals and injected into a petri dish containing 0.5% hydroquinone solution in an ice bath. Monomer conversion was determined gravimetrically from these samples. By changing the weight ratio of between PU and acrylics (acrylate pre-emulsion) from 100:0 to 90:10, 75:25, 65:35, 50:50, 25:75, and 0:100, a series of biobased waterborne polyurethane/acrylic hybrid latexes were prepared.

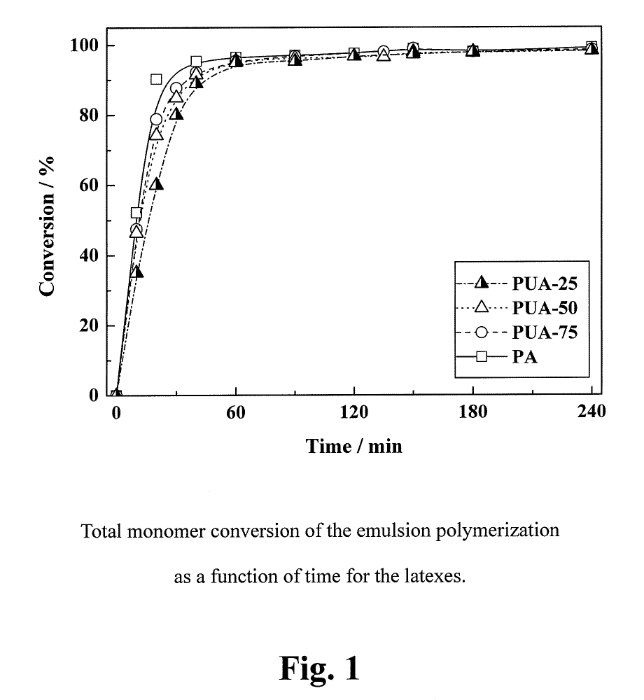

The emulsion polymerization of the pure acrylic was complete within about 30 min, and essentially all of the monomers were polymerized. Polymerization of >97% of the biobased waterborne polyurethane/acrylic hybrid latexes was complete within 2 hours. [The conversion-time profiles for the emulsion polymerization at 80° C. are shown in FIG. 1.]

The biobased waterborne polyurethane/acrylic hybrid latexes containing 15-60 wt % soy polyols were very stable at room temperature and showed no precipitation even after 6 months.

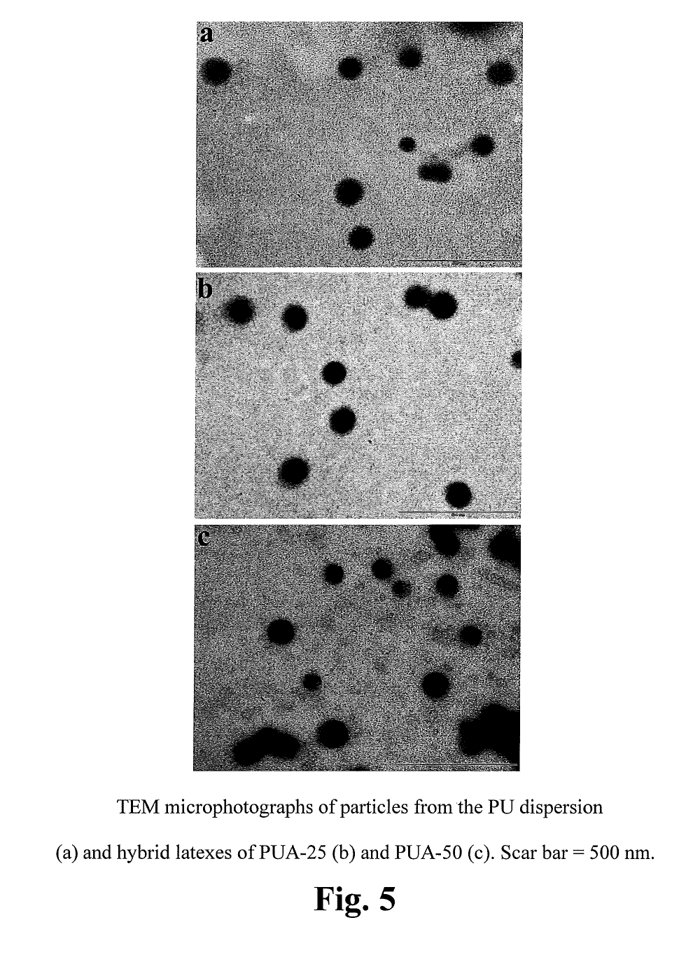

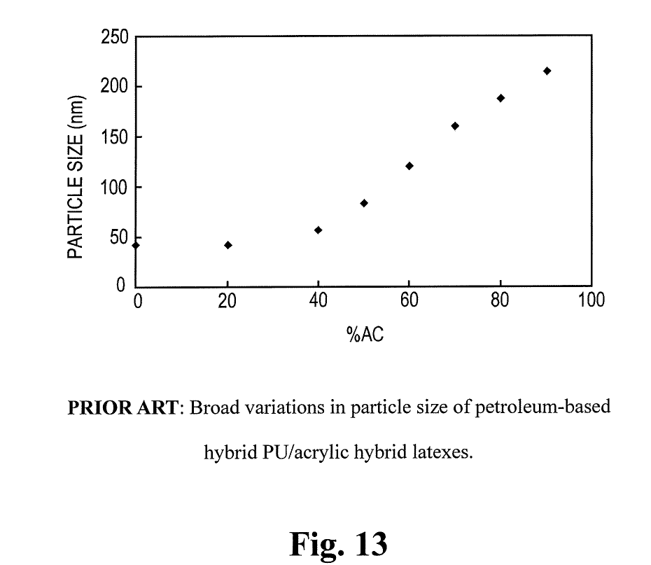

The morphology of the latex particles was observed on a transmission electron microscope (JEOL 1200EX). The emulsions prepared were diluted with deionized water to about 0.4 wt %. One drop of the diluted emulsion was placed on the coated side of a 200-mesh nickel grid in a petri dish. After drying, the samples were characterized. The TEM morphology of the biobased waterborne polyurethane latex and the biobased hybrid latexes is shown in FIG. 5. The TEM confirms that the particle size of the biobased waterborne polyurethane latex and hybrid latexes is very uniform, with an average diameter of 125 +−20 nm. The particle diameter of the biobased hybrid latexes was not related to the contents of acrylics, unlike latexes formed from petroleum. FIG. 13 shows broad variations in the particle size of petroleum-based hybrid PU/acrylic latexes, depending on the acrylic content of the latex (Kukanja et al., The structure and properties of acrylic-polyurethane hybrid emulsions and comparison with physical blends, Journal of Applied Polymer Science, Vol. 78, 67-80, 2000).

The particle size of the final hybrid latexes was unrelated to the ratio of biobased polyurethane to acrylic, indicating that the emulsion process that took place has a different particle growth mechanism from seeded hybrid emulsion polymerization processes. The occurrence of extensive grafting of the acrylics onto the PU and interpenetration between the acrylics and the PU resulted in miscible hybrid latexes with enhanced thermal and mechanical properties. The mechanical properties of these novel hybrid latex films were comparable to those of polypropylene glycol-based PU/acrylic hybrid latex films made from petroleum-based polypropylene glycol.

### EXAMPLE 3

Biobased polyurethane/acrylic hybrid latex films were prepared by drying the biobased polyurethane/acrylic hybrid latex emulsions from Example 2 at room temperature in a glass mold, except for the 100% acrylic film, which was obtained by drying at 45° C. The nomenclature used for the urethane/acrylic hybrid latex film is the following: PU and PA represent films from the polyurethane dispersion and polyacrylate latex, respectively. For the pure acrylate emulsion polymerization, the KPS content was 0.5 wt %, based on acrylate monomers. The biobased polyurethane/acrylic hybrid latex films are identified as PUA-10, PUA-25, PUA-35, PUA-50, and PUA-75, wherein the number represents the weight percent of acrylic in the latex.

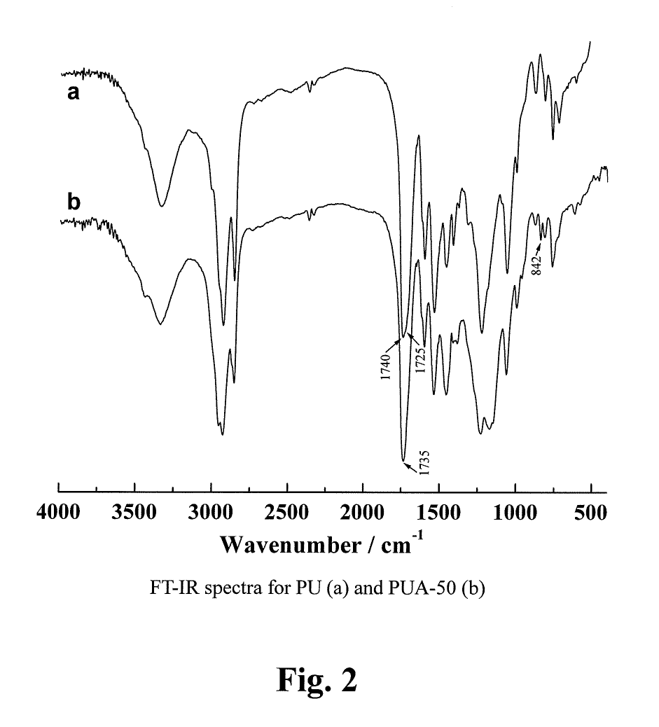

The structure of the films derived from PU and biobased polyurethane/acrylic hybrid latex PUA-50 was characterized by FTIR recorded on a Nicolet 460 FT-IR spectrometer (Madison) using KBr pellets [FIG. 2]. The spectrum of the biobased PU exhibited absorption peaks of a typical PU at 3338 cm−1 (NH, hydrogen-bonded), 3445 cm⁻¹ (NH, non-hydrogen-bonded), 1740 cm−1 (C═O, nonhydrogen-bonded), 1725 cm−1 (C═O, hydrogen-bonded), and 1536 cm−1 (CONH). The spectrum of the PUA-50 exhibits a typical absorption peak for the —OC₄H₉ group at 841 cm−1, indicating the existence of the acrylics in the hybrid latex. However, the absorption of the free C═O groups shifted from 1740 to 1735 cm−1, and the hydrogen-bonded C═O groups at 1725 cm−1 disappeared in the hybrid latex. This implies that the intra- and intermolecular hydrogen bonds of the PU were destroyed due to graft copolymerization of the acrylics and entanglement of the macromolecular chains between the biobased PU and the PA, leading to good miscibility of the resulting biobased polyurethane/acrylic hybrid latex.

The functionality of the biobased polyurethane (PU) dispersion prepared in Example 1 is 2.3, so resulting PU films were thermosetting polymers which did not totally dissolve in organic solvents, such as THF, DMF, DMAc, toluene, methylene chloride, etc.

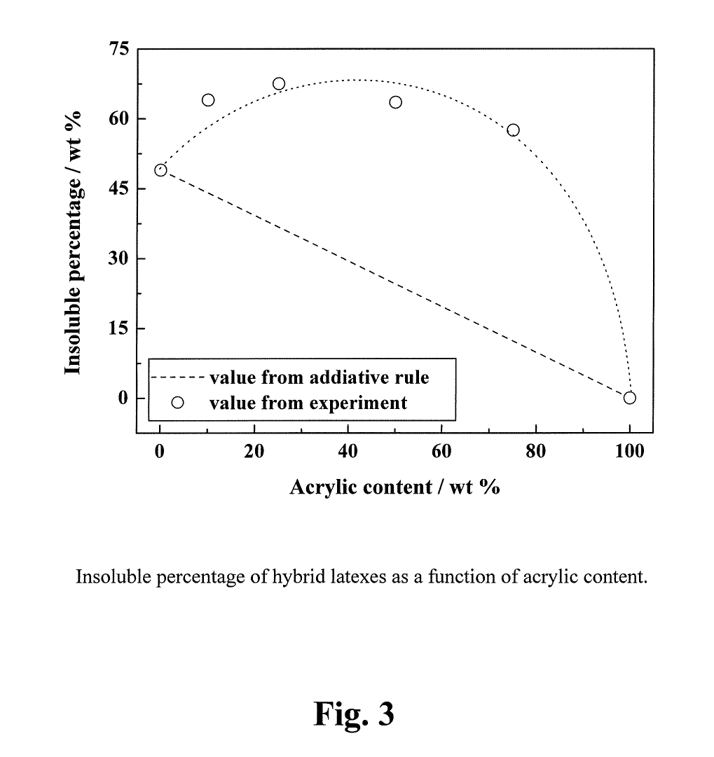

Solvent extraction of films was performed in a Soxhlet extractor with approximately 1 g of dry latex film. The samples were first extracted with toluene for 24 h to remove linear polyacrylates and then with N,N-dimethylformamide (DMF) for 24 h. The residual weight of the vacuum-dried samples was determined and used to calculate the incorporation of acrylates into the PU. FIG. 3 shows the extraction results for the PU and hybrid latexes as a function of PA content. A total of 49 wt % insoluble materials are observed after extraction of the PU film, indicating the network nature of this material. If no crosslinking or grafting between PU and PA took place the hybrid latex would behave like a physical blend of PU and PA, so thus the insoluble percentage of the latex would decrease linearly with an increase in the PA content as shown by the line in FIG. 3. However, the percentage of insoluble materials was significantly greater for the biobased hybrid latexes than that of physical blends, indicating that graft copolymerization reactions and/or crosslinking reactions occurred in the hybrid latex systems.

Generally, the predicted Tg value of a single phased IPN can be calculated from the Fox equation:

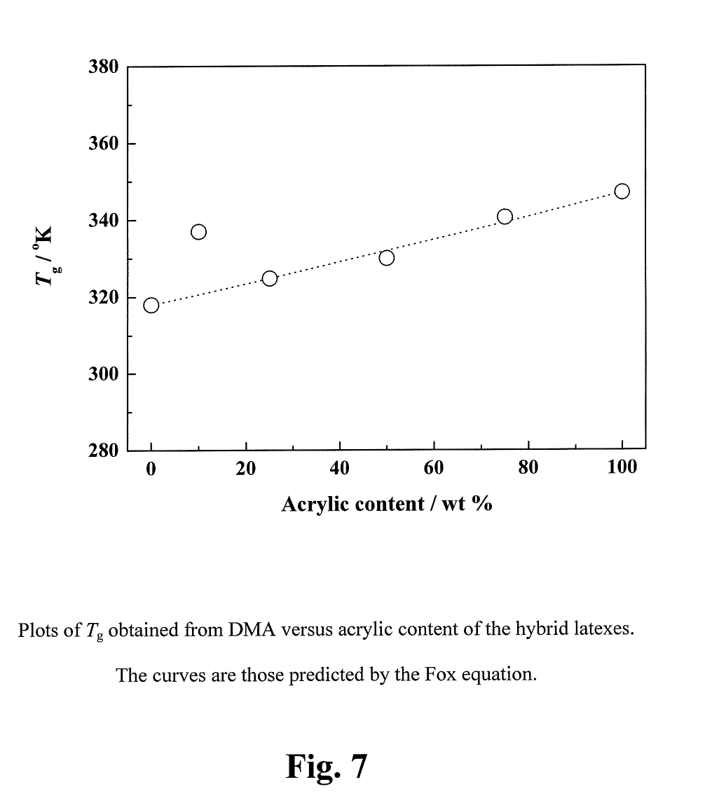

1/T_{g}=w₁/T_{g}1+w₂/T_{g2}

where w1 (w2) and Tg1 (Tg2) are the weight fractions and glass transitions of the polymers 1 and 2, respectively. FIG. 7 shows a comparison of the Tg values of the hybrid latexes obtained from DMA with that predicted from the Fox equation. The experimental values increase with an increase in the acrylic content of the hybrid latexes and fit well with the predicted value, except for PUA-10. This is indicative of high miscibility between the PU and the acrylics due to extensive grafting and interpenetration.

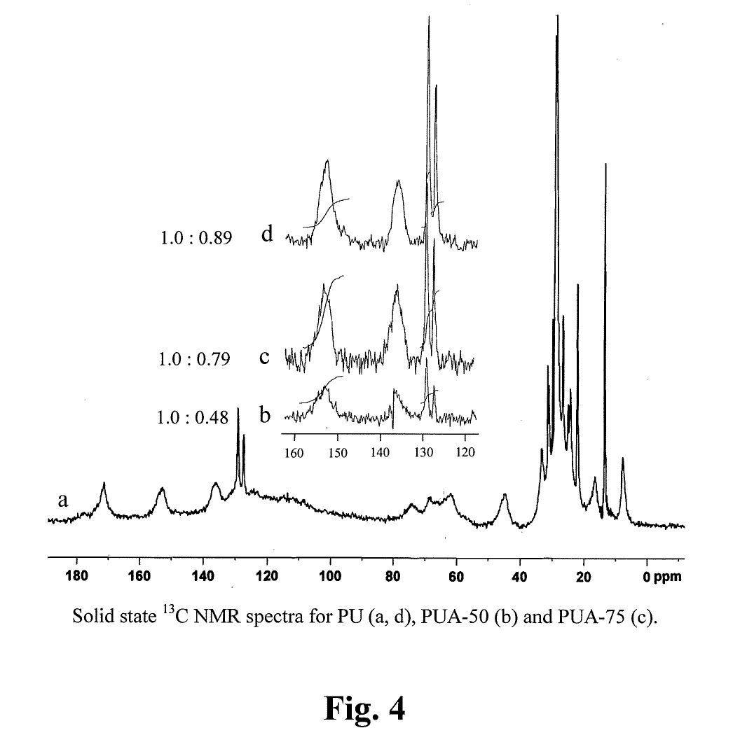

The occurrence of graft copolymerization in the biobased hybrid latex systems was confirmed by solid-state 13C NMR spectra of the PU and hybrid latex films were obtained (FIG. 4). The PU spectrum exhibited characteristic peaks at 152 ppm and 126-133 ppm. The former peak is attributed to the carbon present in the urethane moiety, and the latter peak is mainly attributed to the carbon-carbon double bonds in the biobased polyol. The carbon in the urethane functionality can be used as an internal standard because its concentration was constant during hybrid polymerization. Thus, the ratio between the carbon in the urethane groups and the carbon of the carbon-carbon double bonds in the fatty acid can be used to determine the extent to which the carbon-carbon double bonds in the PU soft segment have polymerized. However, the sixth carbon present in the benzene ring of the 2,4-TDI has a chemical shift of 133 ppm, which also appears by in the same region as the carbon-carbon double bonds. FIG. 4b-d shows the solid state 13C NMR spectra of the biobased PU and biobased hybrid latexes in the region 120-160 ppm after subtraction of the contribution from the sixth carbon of the benzene ring. For pure biobased PU, the ratio between the urethane carbons and the carbons of the carbon-carbon double bonds in the fatty acid is 0.89, which is consistent with the theoretical value of 0.899. However, for films having acrylic content of 50 to 75 wt %, the ratios of these two carbons were 0.79 and 0.48, respectively, implying that some of the carbon-carbon double bonds in the fatty acid have been reacted and copolymerized with the acrylic monomers, which is in good agreement with the extraction results.

The rheological properties of biobased polyurethane/acrylic hybrid latex films as a function of temperature were measured. The dynamic mechanical behavior of the specimens was determined using a dynamic mechanical analyzer (TA instrument DMA Q800) with tensile mode at 1 Hz and a heating rate of 5° C./min in the temperature range from −60 to +100° C. Specimens with a typical size of about 10 mm×5 mm (length×width) were used.

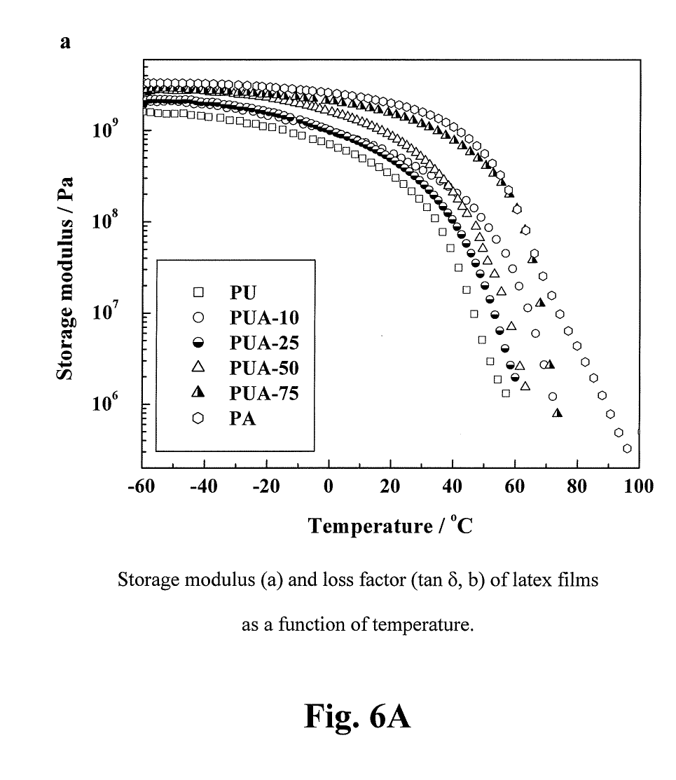

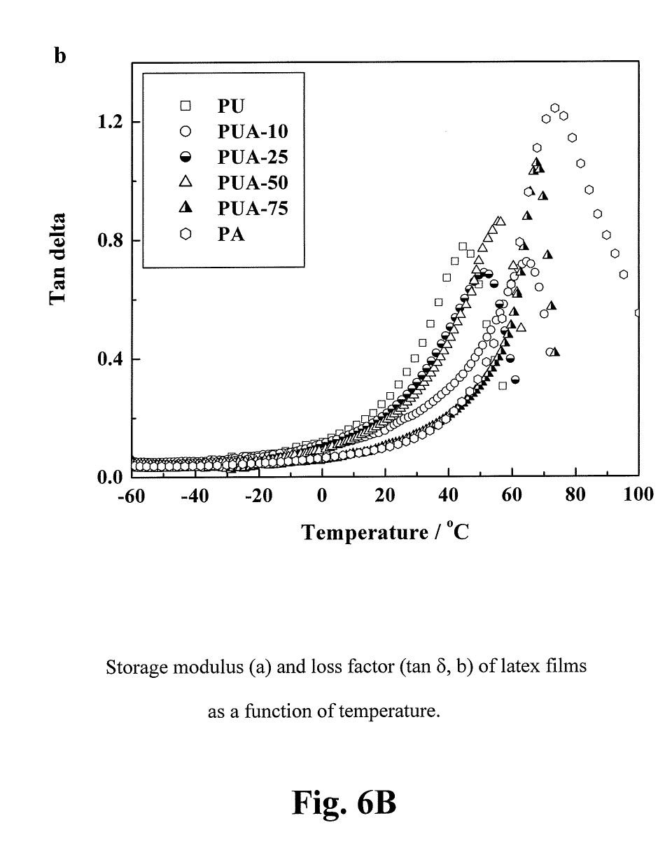

The storage modulus (E′) and loss factor (tan delta) of the latex films as a function of temperature are shown in FIG. 6. The PU film exists in the glassy state at a very low temperature, and the modulus deceases slightly with increasing temperature. Then, a sharp decrease in the E′ value is observed in the temperature range from 10 to 60° C. This corresponds to the primary relaxation process (alpha) of the PU, where the tan delta goes through a maximum (T alpha). Similar to the PU, all latex films exhibited a dramatic drop in the E′ value in the temperature range from 20 to 80° C. When compared with the PU, the E′ values of the resulting latex films were significantly increased due to incorporation of the acrylics by hybrid emulsion polymerization. For instance, the E′ values of the hybrid latex films at room temperature containing 10, 25, 50, and 75 wt % acrylics were approximately 2.0, 1.6, 2.9, and 5.7 times higher, respectively, than the PU itself, indicating the occurrence of grafting and interpenetration between the acrylics and the PU networks. The peak position (T alpha) of tan delta relaxation for the PU and PA, defined as Tg in this work, were about 45 and 75° C., respectively.

All biobased polyurethane/acrylic hybrid latex films exhibited only one narrow loss factor peak in the temperature range 51-68° C., indicating the presence of a single type of polymer system. This loss factor peak was intermediate between the loss factor peaks of the component polymers, indicating that phase separation did not occur. The presence of a single type of polymer system was also indicated by the perfect clarity of the films prepared from biobased synthetic polyurethane/acrylic hybrid latex. The most likely reason for the complete mutual solubility of these hybrid latexes is extensive grafting and interpenetration, forming a mixture of graft-interpenetrating polymer networks (graft-IPN) and semi-interpenetrating polymer networks (semi-IPN), where the acrylics are grafted onto the PU to form a graft-IPN, and the linear ungrafted acrylic polymer can be interpenetrated into the PU network to form another semi-IPN.

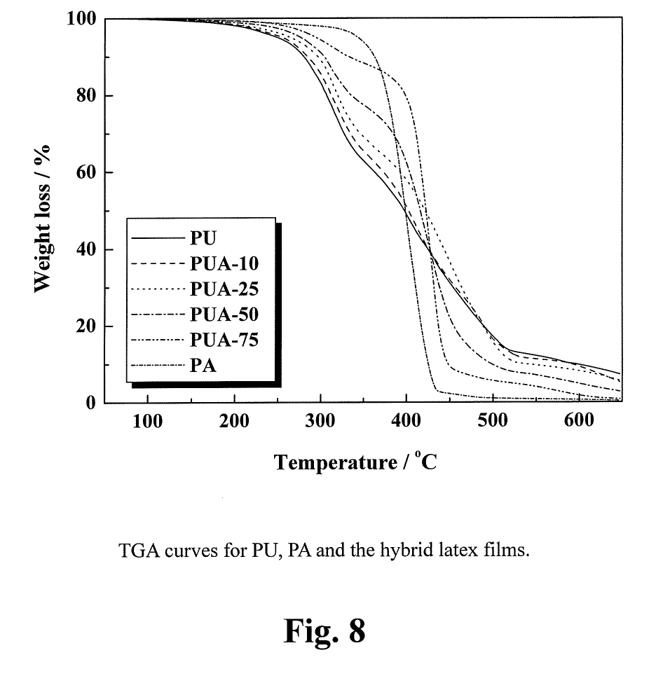

The thermal stabilities of the PU, PA and hybrid latex films were evaluated by TGA as shown in FIG. 8 and the results are summarized in Table 1. A Perkin-Elmer Pyris-7 thermogravimeter was used to measure the weight loss of the latex films under an air atmosphere. The samples were heated from 50 to 650° C. at a heating rate of 20° C./min. Film samples of 10-15 mg were used for the thermogravimetric analysis.

Generally, petroleum-based PU exhibits relatively poor thermal stability, due to dissociation of the urethane bond occurring around 200° C. Petroleum-based PA generally exhibits a one-step thermal degradation, where the maximum degradation occurs at around 400° C. As seen in FIG. 8, the TGA curves of the hybrid latexes below 450° C. shifted to a higher temperature when compared with the pure PU, indicating a higher thermal stability for the hybrid latexes. The interesting parameters for the thermal stability of the hybrid latexes have been taken from the onset of degradation, which is usually taken as the temperature at which 5% degradation occurs (T5), the midpoint temperature of the degradation (T50), the temperature of maximum weight loss rate (Tmax) in each stage, and the nonvolatile residue, which remains at 650° C., denoted as the char. The thermal degradation behavior of the hybrid latexes is largely influenced by the acrylic resin content. Increases in the T5 value from 249 to 294° C. and the T50 value from 397 to 423° C. are observed for the hybrid latexes with an increase in the acrylic content from 0 to 75 wt %. The hybrid latexes exhibit higher T50 values than the pure components, indicating that the hybrid latexes containing biobased polyurethane had greater thermal stability.

TABLE 1
TGA Data for the PU, PA, and Hybrid Latex Films

| sample | T₅/° C. | T₅₀/° C. | Tₘₐₓ/° C. | residue/% |
|---|---|---|---|---|
| PU | 249.1 | 397.2 | 310/409/487 | 7.3 |
| PUA-10 | 254.9 | 402.1 | 309/410/432 | 5.2 |
| PUA-25 | 264.4 | 421.3 | 310/452/492 | 5.5 |
| PUA-50 | 276.2 | 415.8 | 309/424 | 2.7 |
| PUA-75 | 294.1 | 422.5 | 320/430 | 0.8 |
| PA | 343.1 | 398.6 | 402 | 0.4 |

The PU showed three significant thermal degradation peaks at 310, 409, and 487° C., respectively (Tmax in Table 1). However, the corresponding Tmax value of the hybrid latexes shifts to a higher temperature when compared with the pure components. These results indicate that the acrylics play an important role in enhancing the thermal stability of the PU/acrylic hybrid latexes. The improved thermal stability of the hybrid latexes can be explained by the occurrence of extensive grafting, crosslinking, and interpenetration.

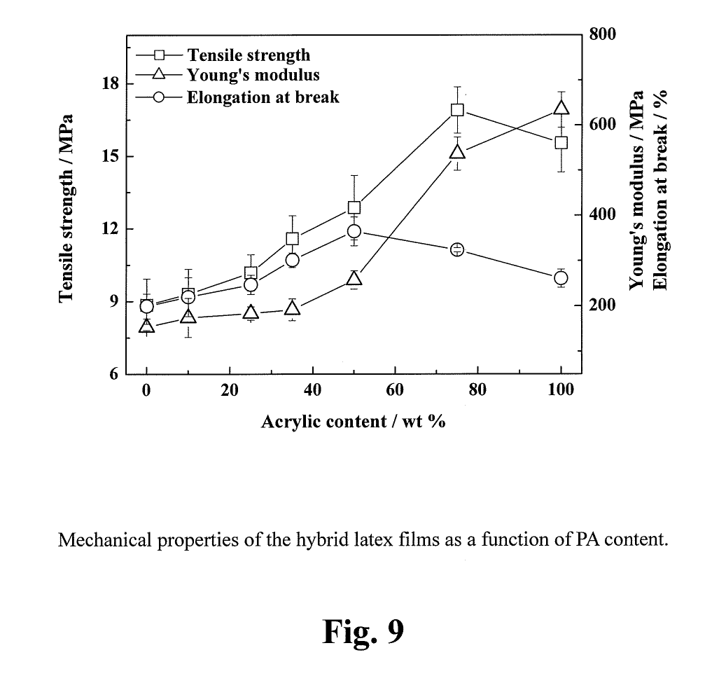

The mechanical properties of the hybrid latexes as a function of the acrylic content are shown in FIG. 9. The mechanical properties of the latex films were determined using an Instron universal testing machine model-4502 with a crosshead speed of 100 mm/min. Rectangle specimens of 80 mm×10 mm (length×width) were used. An average value of at least five replicates of each material was taken.

Young's modulus (E) is a measure of stiffness of a material and is the ratio of stress over strain. This can be experimentally determined from the slope of a stress-strain curve created during tensile tests conducted on a sample of the material. The Young's modulus, tensile strength, and elongation at break of the PU film were 154 MPa, 8.8 MPa, and 200%, respectively. For the hybrid latex films, both the Young's moduli and the tensile strengths were much higher, indicating stronger, stiffer films. Moreover, unlike petroleum-based PU/acrylic hybrid latex emulsions, the stiffness (Young's modulus) of biobased PU/acrylic hybrid latex films increased with increasing content of acrylic. The behavior of petroleum-based PU/Acrylic hybrid emulsions as characterized by Kukanja et al., is opposite, and the Young's modulus decreases with increasing content of acrylic (Table 2).

TABLE 2
Young's modulus increases with increasing acrylic content
in petroleum-based polyurethane/acrylic hybrid emulsion films.

| Acrylic content % | 0 (polyurethane) | 20 | 40 | 50 | 60 | 80 |
|---|---|---|---|---|---|---|
| Young's modulus | 450 | 323 | 165 | 125 | 73 | 23 |
| Tensile strength | 20.7 | 20.7 | 17.6 | 12.3 | 14.8 | 10.2 |

From Kukanja et al. Young's modulus and tensile strength values are given in MPa, which is equivalent to N/mm².

The elongation at break of the hybrid latex films first increases with increasing acrylic content and reaches a maximum of 365% at 50 wt % acrylic content.

The tensile strength of films made from biobased PU/acrylic unexpectedly increased with increasing acrylic content (FIG. 9). In hybrid latex films made from petroleum passed PU, the tensile strength decreases as the acrylic content increases (Table 2).

These improvements in the mechanical properties of the hybrid latex films can be attributed to extensive grafting and interpenetration between the biobased PU and the acrylics, resulting in the highly miscible hybrid latexes. As mentioned earlier, due to the poor miscibility between component polymers, physically blended films from a PU dispersion and a PA emulsion are very brittle when the PA content is higher than 30 wt %. However, hybrid latex films with good mechanical properties can be prepared over the entire range of composition by hybrid emulsion polymerization technology.

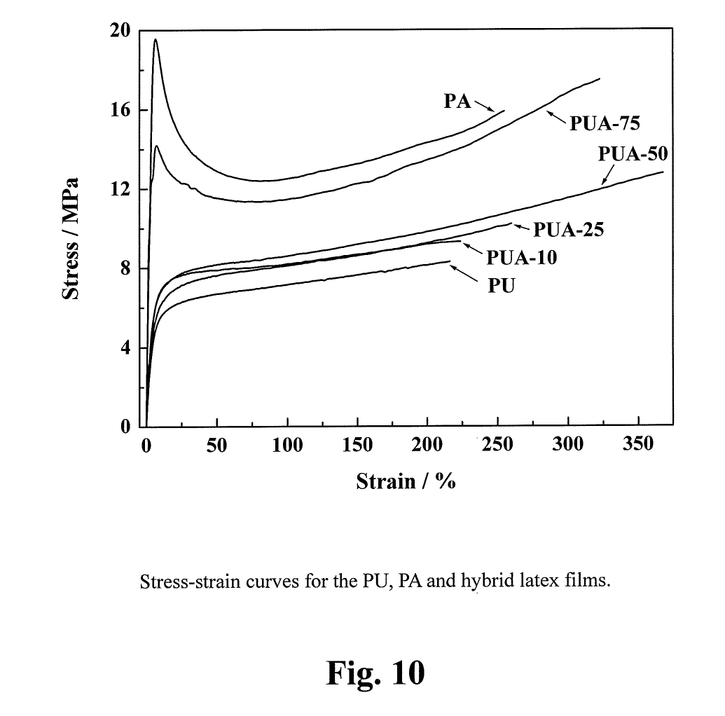

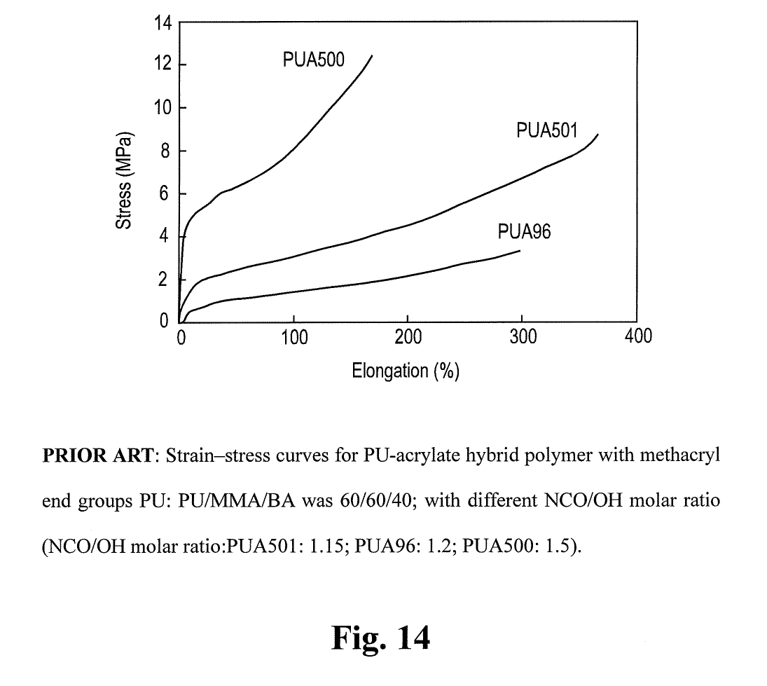

The mechanical properties of the novel biobased hybrid latex films containing 15-60 wt % of the biobased SOL are superior to those based on polyurethane from petroleum sources. FIG. 10 shows the stress-strain (also known as stress-elongation curves) curves for the PU, PA, and hybrid latex films. The deformation feature of the hybrid latex films at room-temperature greatly depends on the acrylic content. When the acrylic content is less than 50 wt %, the latex films exhibit characteristics typical of soft and tough polymers that show uniform extension. However, the hybrid latex film containing 75 wt % acrylics displays behavior typical of rigid and tough plastics with a necking down across the width of the specimen, similar to the behavior of the PA copolymers. For comparison, published stress-strain curves of comparable polymers made from petroleum-sourced polypropylene glycol are shown in FIG. 14. (FIG. 7 from Wang, et al. Hybrid polymer latexes—acrylics-polyurethane: II. Mechanical properties, Polym. Adv. Technol. 2005; 16: 139-145; Published online 17 Jan. 2005). The biobased PU/acrylic hybrid films underwent less elongation at higher stress levels than the petroleum samples, indicating significantly better mechanical strength in the biobased films. In addition, the elongation at break of the biobased PU/acrylic hybrid film was greater than the elongation at break of a polyurethane film and of a polyacrylate film (FIG. 9).

What is claimed is:

1. A composition comprising a biobased waterborne polyurethane/acrylic hybrid latex.

2. The composition of claim 1, wherein the biobased waterborne polyurethane/acrylic hybrid latex is prepared by graft copolymerization or crosslinking.

3. The composition of claim 1, wherein the double bonds of fatty acids of the biobased waterborne polyurethane/acrylic hybrid latex are copolymerized with acrylic monomers.

4. The composition of claim 1, wherein the particle size of the hybrid latex solids are 125±20 nanometers.

5. The composition of claim 1, wherein the biobased waterborne polyurethane/acrylic hybrid latex comprises graft-interpenetrating polymer networks and semi-interpenetrating polymer networks.

6. The composition of claim 1, wherein the biobased waterborne polyurethane/acrylic hybrid latex comprises soybean oil polyol or epoxidized soybean oil polyol.

7. A film made from the composition of claim 1.

8. A film according to claim 7, which displays or is characterized by only one loss factor peak.

9. A film according to claim 7, which is characterized by a temperature-dependent storage modulus behavior between that of polyurethane and a polyacrylate film.

10. A film according to claim 7, which is characterized by a thermal stability greater than the thermal stability of a polyurethane film, in that the temperature at which 5 percent degradation of the biobased polyurethane/acrylic hybrid latex film occurs is greater than the temperature at which 5 percent degradation of the polyurethane film occurs.

11. A film according to claim 7, which is characterized by a thermal stability greater than the thermal stability of a polyurethane film, in that the temperature at which 50 percent degradation of the biobased polyurethane/acrylic hybrid latex film occurs is greater than the temperature at which 50 percent degradation of the polyurethane film occurs.

12. A film according to claim 7, which is characterized by a stiffness greater than the stiffness of a polyurethane film.

13. A film according to claim 7, which is characterized by a tensile strength greater than the tensile strength of a polyurethane film or a polyacrylate film.

14. A film according to claim 7, which is characterized by an elongation at break greater than the elongation at break of a polyurethane film or a polyacrylate film.
